(19) United States
(12) Patent Application Publication
(10) Pub. No.: US 2005/0002032 A1
(43) Pub. Date: Jan. 6, 2005

(54) Non-contact optical polarization angle encoder

(76) Inventors: Geert Johannes Wijntjes, Chelsea, MA (US); Constantine T. Markos, Lynn, MA (US)

Correspondence Address: Iandiorio & Teska, 260 Bear Hill Road, Waltham, MA, 02451-1018, US

(21) Appl. No.: 10/839,073

(22) Filed: May 5, 2004

Related U.S. Application Data
(63) Continuation-in-part of application No. 10/288,875, filed on Nov. 6, 2002.
(60) Provisional application No. 60/333,288, filed on Nov. 6, 2001.
(60) Provisional application No. 60/468,286, filed on May 5, 2003.

(51) Int. Cl. G01D 5/34; G01J 4/00

(52) U.S. Cl. 356/364; 250/231.16; 250/225

(57) ABSTRACT

An optically coupled rotary encoder that is capable of measuring and encoding the angle of rotation of a rotating or stationary object. A polarizer rotates synchronously with the rotatable object and inputs broadband or single frequency unpolarized light. The polarizer outputs and directs polarized light towards a plurality of fixed analyzers and light detectors. Each fixed analyzer outputs and directs further polarized light towards one of the light detectors. Each light detector outputs an electrical signal to a phase processor based upon one attribute of the further polarized light. The phase processor outputs a phase angle with high resolution (>12 bit) with high accuracy and frequency (5 MHz). The system and method can operate in harsh environments having high temperatures, dirt and debris and is not susceptible to EMI/RFI.

### RELATED APPLICATIONS

This application is a continuation in part of U.S. Ser. No. 10/288,875, filed Nov. 6, 2002, and claims benefit of U.S. Provisional Application Nos. 60/468,286, filed May 5, 2003 and 60/333,288 filed Nov. 6, 2001 (priority application for Ser. No. 10/288,875), all of which are herein incorporated by reference.

### GOVERNMENT LICENSE RIGHTS

The U.S. Government has a paid up license in this invention and the right in limited circumstances to require the patent owner to license others on reasonable terms as provided for by the terms of SBIR contract number NSF00-48/CFDA#47.041, award number 0109171.

### FIELD OF THE INVENTION

This invention relates to a non-contact optical angle of rotation encoding system and method and more particularly to a system which enables measurement of the angle of rotation of a rotating or fixed object.

### BACKGROUND OF THE INVENTION

Most prior art angle of rotation encoders involve the use of code wheels, magnetic encoders or hall effect sensors. The manufacturing of code wheels requires stamping or lithographic etching, which are both expensive processes. Furthermore, the function of the code wheel is limited to optical diffraction. This constrains the size of code wheels to larger devices.

Magnetic encoders are susceptible to interference when used in high-speed systems, such as turbines. Also, magnetic encoders of the two phase (resolver) or the three phase (synchro) transmitter design, are expensive, have a limited maximum RPM and require an AC power source that further increases their cost. Hall effect sensors provide relatively low signal levels and have temperature limitations, making them vulnerable to electromagnetic interference (EMI).

Also, many angle of rotation encoders have significant mass and are required to be attached to a rotating object, such as a rotating shaft, resulting in a substantial limitation upon smaller mechanical systems (such as disk drives or medical devices, etc.). Angle of rotation encoders may also be limited in their ability not to reduce the size of holes in their encoders since light will not adequately pass through the holes if the holes are too small.

There are other types of angle of rotation encoders, such as interferometric based units and potentiometer based units. These devices are cost prohibitive and are limited with respect to the number of rotations of an object that can be accurately encoded.

### SUMMARY OF THE INVENTION

It is therefore an object of this invention to provide a non-contact optical system and method of measuring and encoding the angle of rotation of an object that is more accurate at higher frequencies and which exhibits a greater tolerance to environmental extremes.

It is a further object of this invention to provide a system and method of accurately measuring and encoding the angle of rotation of an object with a sampling frequency substantially in excess of the prior art.

It is a further object of this invention to provide a system and method of accurately measuring and encoding the angle of rotation (orientation) of multiple stationary (non-rotating) objects.

It is a further object of this invention to provide a system and method of accurately measuring and encoding the angle of rotation of a crankshaft of an advanced automotive powertrain, such as a crankshaft of an electric or hybrid electrical vehicle.

The subject invention results from the realization that an improved method of measuring and encoding the angle of rotation of a stationary or rotating target object is achieved by employing a light source and a rotatable polarizer having an angle of rotation that is synchronous with the angle of rotation of a target object, by employing a plurality of analyzers (fixed polarizers), a plurality of light detectors configured to output a signal in response to at least one attribute of the light polarized by each respective one of the plurality of analyzers, and a phase processor configured to compute a value representing the angle of polarization of light directed from the rotatable polarizer in response to the input of a signal from each of the plurality of light detectors.

In one preferred embodiment, an angle of rotation encoder includes a first plurality of analyzers, each responsive to light originating from a light source and configured to polarize the light at a unique angle of polarization, a first plurality of light detectors, each configured to receive light polarized by a unique one of the first plurality of analyzers and configured to output a signal in response to at least one attribute of the polarized light and a phase processor configured to compute a value representing an angle of polarization attribute of the light originating from the light source in response to the input of the electrical signal from each of the first plurality of light detectors.

Preferably, the at least one attribute of the polarized light includes a measurement of the optical power. Preferably, the phase processor simultaneously samples the electrical signal from each of the first plurality of light detectors.

Optionally, the angle of rotation encoder can further include a second light detector configured to receive light not being polarized by any of the first plurality of analyzers.

In one embodiment, the angle of rotation encoder further includes a polarizer configured to rotate synchronously with a first object, configured to be responsive to light originating from the light source and configured to direct light originating from the light source to the first plurality of analyzers. In this embodiment, the first object is rotatable and the polarizer is configured to rotate synchronously with the first object.

In one embodiment, the angle of rotation encoder further includes a polarizer configured to have an angle of rotation that is synchronous with a first object, configured to be responsive to light originating from the light source and configured to direct light originating from the light source to the first plurality of analyzers. Optionally, the polarizer is disposable or detachable and re-usable on at least a second object.

In one embodiment, the first plurality of analyzers includes at least three analyzers that each have a unique angle of polarization. Preferably, the first plurality of analyzers includes three analyzers having angles of polarization approximately 120 degrees apart.

In one embodiment, the polarizer is attached to the first object and reflecting light originating from the light source towards the first plurality of analyzers. In another embodiment, the polarizer is attached to the first object and allows the passage of light originating from the light source towards the first plurality of analyzers. Optionally, the light originating from the light source is transmitted to the polarizer through an optical fiber. Optionally, the first plurality of light detectors receives light from a unique one of the first plurality of analyzers through an optical fiber.

In some embodiments, the angle of rotation encoder further includes a non-polarizing light beam splitter configured to receive light from the polarizer and to output at least a first plurality of light beams, each of the light beams being directed to a unique one of the first plurality of analyzers. Optionally, at least one of the at least a first plurality of light beams is output directly towards the second light detector.

In another embodiment, the invention provides a method of encoding the angle of rotation of an object including the steps of providing a first plurality of analyzers, each responsive to light originating from a light source and configured to polarize the light at a unique angle of polarization, providing a first plurality of light detectors, each configured to receive light polarized by a unique one of the first plurality of analyzers and configured to output a signal in response to at least one attribute of the polarized light; and providing a phase processor configured to compute a value representing an angle of polarization attribute of the light originating from the light source in response to the input of the electrical signal from each of the first plurality of light detectors.

### BRIEF DESCRIPTION OF THE DRAWINGS

Other objects, features and advantages will occur to those skilled in the art from the following description of a preferred embodiment and the accompanying drawings, in which:

FIG. 1 is a simplified block diagram illustrating the basic principals of encoding an angle of rotation of an object, such as a polarizer, using an analyzer (fixed polarizer) and a light detector;

FIG. 2 illustrates the intensity of light received by the light detector of FIG. 1 as a function of the relative angle of polarization of the polarizer as compared to the angle of polarization of each or any analyzer;

FIG. 3 illustrates the intensity of light received by the light detector of FIG. 1 as a function the relative angle of polarization of the polarizer as compared to a reference angle of polarization;

FIG. 4 is a simplified block diagram, in accordance with the subject invention, of a system for high precision and non-contact encoding of an angle of rotation of an object, such as a polarizer;

FIG. 5 is simplified block diagram illustrating, in accordance with an embodiment of the subject invention, the system shown in FIG. 4 utilizing a reflective polarizer;

FIG. 6 is simplified block diagram illustrating, in accordance with an embodiment of the subject invention, the system shown in FIG. 5 optical fiber links;

FIG. 7 is simplified block diagram illustrating, in accordance with an embodiment of the subject invention, the system shown in FIG. 4 utilizing a transmissive polarizer, FIG. 8 is a simplified block diagram illustrating, in accordance with an embodiment of the subject invention, a system for non-contact encoding of the angle of rotation of an object utilizing a non-polarizing beam splitter;

FIG. 9 is a simplified block diagram illustrating, in accordance with an embodiment of the subject invention, a system for non-contact encoding of the angle of rotation (orientation) of multiple stationary (non-rotating) objects;

FIG. 10A is simplified block diagram, in accordance with another embodiment of the subject invention, of a system for high precision and non-contact encoding of an angle of rotation of an object, such as a polarizer;

FIG. 10B is a graph of the three signals output from the three detectors of the system of FIG. 10A;

FIG. 11 is a graph showing the top, middle and bottom signals at time ti for the signals that are output from the system of FIG. 10A;

FIG. 12 is a graph that shows the reference amplitude and measured amplitude signals for the signals shown on the graph of FIG. 11;

FIG. 13 is a block diagram of an analog to digital converter for the system of 10A;

FIG. 14 is one embodiment of a polarizing wheel that includes a 2 bit encoder for use with the system of FIG. 10A;

FIGS. 15A-15C are schematic views of another embodiment of a polarizing wheel for use with the system of FIG. 10A; and

FIGS. 16A and 16B are block diagrams of one example of the electronic subsystems for the system of FIG. 10A.

### DISCLOSURE OF THE PREFERRED EMBODIMENT

Aside from the preferred embodiment or the embodiments disclosed below, this invention is capable of other embodiments and of being practiced or being carried out in various ways. Thus, it is to be understood that the invention is not limited in its application to the details of construction and the arrangements of the components set forth in the following description of the invention or illustrated in the drawings in accordance with the invention.

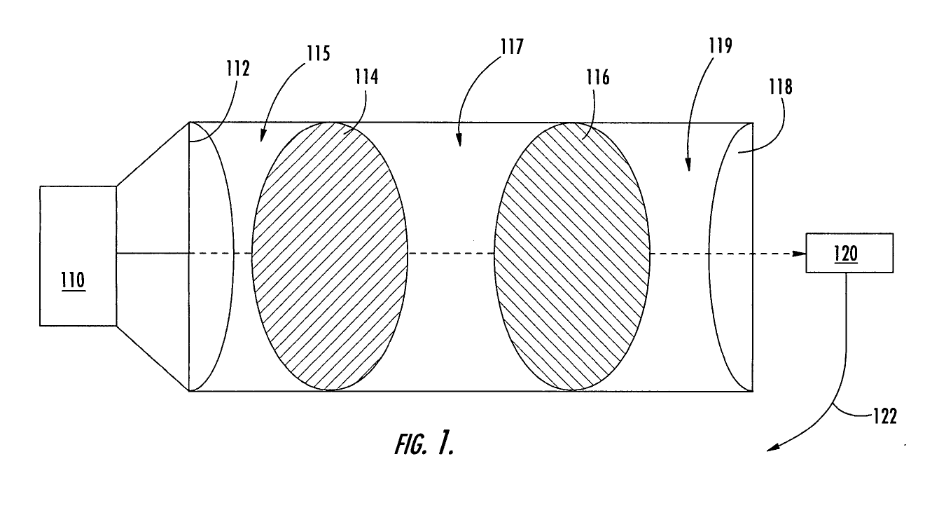

FIG. 1 is a simplified block diagram illustrating the basic principals of encoding an angle of rotation of an object, such as a polarizer 114, using an analyzer 116 (fixed polarizer) and a light detector 120. The position of the polarizer 114 may be fixed or rotating. A light source 110 projects light 115 through a lens 112 and towards a rotating polarizer 114. The light 117 passes through the rotating polarizer 114 and towards the analyzer 116. The analyzer 116 is a fixed polarizer. Light 119 passes through the analyzer 116 and through a lens 118 and towards a light detector 120. The light detector 120 generates an electric signal 122 that represents at least one attribute of the light 119 received by the light detector 120.

The rotating polarizer 114 and the analyzer 116 each polarize light at a particular angle of polarization. The angle of polarization of each device, 114 or 116, is dependent upon the angle of rotation of each device 114 or 116, respectively. When both the rotating polarizer 114 and the analyzer 116 are positioned at the same angle of polarization, the maximum amount of light passes through both the polarizer 114 and the analyzer 116. When both devices 114 and 116 are positioned at the same angle of polarization, they are positioned at the same angle of rotation.

When the polarizer 114 and the analyzer 116 are positioned at angles of polarization (rotation) that are 90 degrees apart from each other, the minimum amount of light passes through the rotating polarizer 114 and the analyzer 116. The intensity of the light 119 received by the light detector 120 is indicative of the amount of light passing through the polarizer 114 and the analyzer 116 and indicative of the relative difference between the angles the polarization (rotation) between the rotating polarizer 114 and the analyzer 116. Likewise, the amplitude of the electrical signal 122, expressed in terms of signal current, is also indicative of the intensity of the light received by the light detector 120.

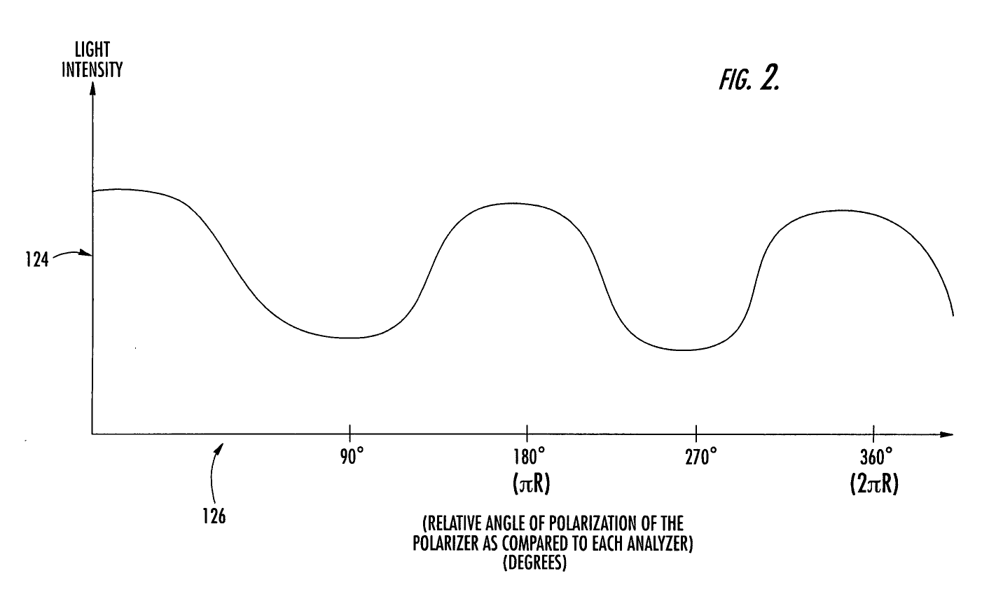

FIG. 2 illustrates the intensity 124 of light received by the light detector 120 as a function of the relative angle of polarization (rotation) of the polarizer 114 as compared to the angle of polarization (rotation) of the analyzer 116. The intensity of the light 119 is measured by the light detector 120 after the light 119 has passed through the polarizer 114 and the analyzer 116. Each half turn of the polarizer 114 alters its angle of polarization (rotation) and alters the relative difference between the angle of polarization (rotation) of the polarizer 114 and of the analyzer 116, by 180 degrees. Each half turn of the polarizer 114 causes the intensity of the light 119 to oscillate through one full sinusoidal cycle of light intensity 124 as shown.

The intensity 124 of the light 119 is maximized when the angle of polarization (rotation) of the polarizer 114 differs from the angle of polarization (rotation) of the analyzer 116 by a value of 0 degrees or by a multiple of 180 degrees. For example, the angle of polarization (rotation) difference values that maximize the intensity of the light 119 include 0, 180, 360 and 540 degrees etc.

The intensity 124 of the light 119 is minimized when the difference between the angle of polarization (rotation) of the polarizer 114 and of the analyzer 116 is a an odd multiple of 90 degrees. For example, angle of polarization (rotation) difference values that minimize the intensity of the light 119 include 90, 270 and 450 degrees etc.

In one embodiment, the light detector 120 includes a photodiode (not shown) that produces an electrical signal 122 having a current that is proportional to the intensity 124 of the light 119 received by the light detector 120. The electrical signal current (I) 122 generated by the light detector 120 expressed as a function of the relative angle of polarization (rotation) (Ω) between the polarizer 114 and a reference angle of polarization (rotation), is as follows:
I(Ω)=K[Pₒ+m Pₒ sin(2(Ω+Ωₒ))]
where (K) is a constant, (Pₒ) is an optical power value, (m) is a modulation efficiency value; (Ω) is a relative angle of polarization (rotation) value and (Ωₒ) is a relative angle of polarization (rotation) offset value.

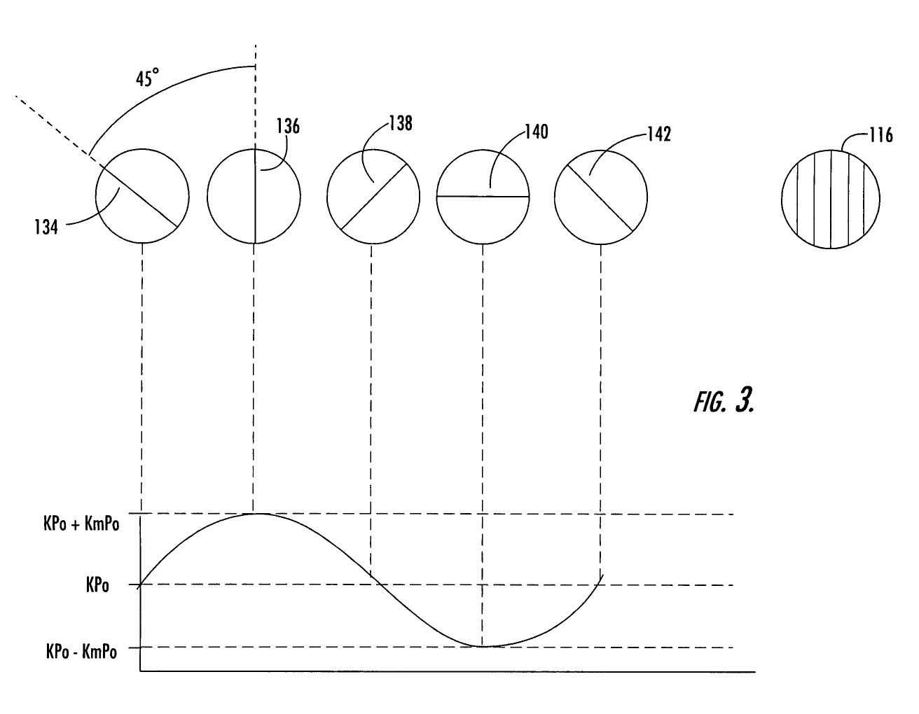

FIG. 3 illustrates the amplitude of the current I (Ω) 122 generated by the light detector 120 as a function of the relative angle of polarization (rotation) of the polarizer 114 as compared to a reference angle of polarization (rotation) 134. The amplitude of the current I (Ω) 122 generated by light detector 120 is proportional to the intensity 124 of light 119 received by the light detector 120.

The reference angle of polarization (rotation) 134 is depicted as being 45 degrees offset (counter clockwise) from a vertical angle of polarization (rotation) 136. In this illustration, the analyzer 116 is positioned at the vertical angle of polarization (rotation) 136, corresponding to Ωₒ=0 degrees.

When the polarizer 114 is positioned at the reference angle of polarization (rotation) 134, the amplitude of the current I (Ω) 122 generated by light detector 120 is equal to (K) (Pₒ). When the polarizer 114 is positioned at the vertical angle of polarization (rotation) 136, 45 degrees offset from the reference angle of polarization, the amplitude of the current I (Ω) 122 generated by light detector 120 is equal to (K) (Pₒ)+(K)(m)(Pₒ).

When the polarizer 114 is positioned at 90 degrees (clockwise) offset 138 from the reference angle of polarization 134, equal to 45 degrees (clockwise) offset from the vertical angle of polarization (rotation) 136, the amplitude of the current I (Ω) 122 generated by the light detector 120 is again equal to (K) (Pₒ).

When the polarizer 114 is positioned at 135 degrees (clockwise) offset 140 from the reference angle of polarization 134, equal to 90 degrees (clockwise) offset from the vertical angle of polarization (rotation) 136, the amplitude of the current I (Ω) 122 generated by the light detector 120 is again equal to (K) (Pₒ)−(K)(m)(Pₒ).

When the polarizer 114 is positioned at 180 degrees (clockwise) offset 142 from the reference angle of polarization 134, equal to 135 degrees (clockwise) offset from the vertical angle of polarization (rotation) 136, the amplitude of the current I (Ω) 122 generated by the light detector 120 is again equal to (K) (Pₒ).

The aforementioned angles of polarization (rotation) of the polarizer 114 span one entire 180 degree sinusoidal cycle of electrical current amplitude, which is proportional to the intensity 124 of light received by the light detector 120, as shown.

In summary, when Ωₒ=0, the reference angle of polarization (rotation) of the polarizer is 45 degrees apart (counter clockwise) from a position that is aligned with the angle of polarization (rotation) of the analyzer 116. When Ωₒ=0 degrees, the amplitude of the current of the electrical signal 122 is maximized at Ω=45 degrees and at any multiple of 180 degrees plus 45 degrees. For example, the angle of polarization (rotation) difference values (Ω), which maximize the amplitude of the current of the electrical signal 122, include 45, 225, and 405 degrees etc.

The amplitude of the current I(Ω) 122 generated by the light detector 120 includes a direct current (DC) component and an alternating current (AC) component. The AC component transitions through 2 complete cycle per revolution, (1 complete cycle per half revolution), of the polarizer 114.

The maximum or minimum amplitude of the electrical signal current I(Ω) 122 may not be a constant value. For example, the maximum current may differ between the angle of polarization (rotation) values of 0, 180 and 360 degrees. Likewise, the minimum current may differ between the angle of polarization (rotation) values of 90, 270 and 450 degrees.

The amplitude of the sine wave representing the electrical signal current I(Ω) 122, is measured from the “middle” current value of the sine wave (KPₒ) and not from the lowest current value to (K) (Pₒ)−(K)(m)(Pₒ). The DC component may raise both the minimum and maximum current values of the sine wave, but not necessarily the amplitude of the sine wave, because in theory, the DC component raises both the minimum and the maximum equally and at any one instant in time.

The value (K) is a constant that converts an optical power value of the light 119 detected by the light detector 120, expressed in units of watts, to an electrical current expressed in units of amperes. The optical power of the light 119 received by the light detector 120 is proportional to the intensity 124 of the light 119 received by the light detector 120.

The variable (Pₒ) is an optical power value, detectable by the light detector 120, that causes the light detector 120 to generate the underlying direct current (DC). The underlying DC current is represented by (K) (Pₒ).

The modulation efficiency variable (m), is expressed as a value between 0 and 1 and represents the efficiency of the light detector 120 with regard to its modulation of the output current 122 based upon the measured optical power of the light 119.

The relative angle of polarization (rotation) (Ω) and (Ωₒ) both express the rotational position of an object, such as the rotational position of the polarizer 114, expressed in terms of the number of whole and/or fractional rotations.

The variables (Pₒ), (m) and (Ω) are time dependent and can change independently from each other. Consequently, the underlying DC component (KPₒ) and the AC component (m Pₒ sin(2(Ω+Ωₒ))), both being dependent upon (Pₒ), are also time dependent and can change independently from the rotation of the polarizer 114. The AC component (m Pₒ sin(2(Ω+Ωₒ))), is additionally dependent upon (m), and can change independently from the DC component and independently from the rotation of the polarizer 114.

FIG. 4 is a simplified block diagram, in accordance with the invention, of a system for high precision and non-contact encoding of an angle of polarization (rotation) of an object, such as a polarizer 114. The position of the polarizer 114 may be fixed or rotating.

This embodiment employs three analyzers (fixed polarizers) 116A-116C, four light detectors 120A-120D outputting electrical signals 122A-122D into a phase processor 130. The phase processor 130 outputs a value represented by a signal 132 that encodes the angle of rotation of the rotating object 114 over time.

The phase processor 130 is capable of simultaneously sampling the electrical signals 122A-122D at a rate of 5 MHz. Sampling the angle of rotation of a rotating object at 5 MHz far exceeds the sampling rates provided by the prior art.

Like shown in FIG. 1, a light source 110 projects light 119 through a lens 112 towards a rotating polarizer 114. The light 119 passes through a rotating polarizer 114 towards the analyzers 116A-116C. The analyzers 116A-116C are fixed polarizers. The light 119 passes through the analyzers 116A-116C and is directed through a lens 118 and towards light detectors 120A-120D. The light detectors 120A-D each generate an electric signal 122A-122D that represents at least one attribute, possibly only an intensity attribute, of the light 119 received by the light detectors 120A-120D.

Each of the analyzers 116A, 116B and 116C are configured to polarize the light 119 at a unique and different angle of polarization. Preferably, the angles of polarization of the analyzers 116A, 116B and 116C are 120 degrees apart. Each of the light detectors 120A, 120B and 120C are configured to receive the light 119 polarized by a unique one of the analyzers 116A, 116B and 116C, respectively. Light detector 120A receives light only passing through analyzer 116A. Light detector 120B receives light only passing through analyzer 116B. Light detector 120C receives light only passing through analyzer 116C. Light detector 120D is configured to receive light 119 that passes through the polarizer 114 but that does not pass through the analyzers 116A-116C.

Each of the light detectors 120A-120D output an electrical signal having a current amplitude that is proportional to the intensity (power) of the light 119 received by it 120A-120D. These electrical signals 122A-122D are simultaneously transmitted to the phase processor 130. The phase processor 130 in response processes these signals 122A-122D and outputs a signal 132 representing the angle of rotation of the polarizer 114 for each instance in time over a period of time. As such, the phase processor 180 is configured to compute a value representing an angle of polarization attribute of the light originating from the light source in response to the signal output from each of the light detectors 120A-120C.

Each of the three simultaneous electrical signals 122A-122C are dependent upon the same instantaneous value of (Pₒ), (m) and (Ω) at one instance in time. Each of the simultaneous electrical signals depends upon a unique and different (Ωo) which is dependent upon the unique angle of polarization of the analyzer 116A-116C associated with the particular electrical signal 122A-122C.

The 3 simultaneous electrical signals 122A-122C provide 3 independent equations for I(Ω) that each have 3 unknown variables (Pₒ), (m) and (Ω). The 3 equations that model each of the electrical signals 122A-122C (I_{R}, I_{S}, I_{T}) are listed below.
I_{R}(Ω)=K [Pₒ+m Pₒ sin(2(Ω+0))]
I_{S}(Ω)=K [Pₒ+m Pₒ sin(2(Ω+1/3))]
I_{T}(Ω)=K [Pₒ+m Pₒ sin(2(Ω+2/3))]

The orientation of the angle of polarization for each analyzer 116A-116C are offset by 60°, (120° electrical), thereby producing 3 signals that in principle are equal except for a 120° ⅓ cycle phase difference. Having three independent equations with three unknowns allows for an unambiguous solution for Ω, modulo (½ cycle or shaft turn).

Mathematically, these three signals can be transformed (condensed) into a pair of quadrature signals, sine and cosine by the algebraic step, the equivalent of a Schott-T transformation. These quadrature signals are listed below.
I_{X}=√3/2(S−T)=Km Pₒ sin 2Ω
I_{Y}=R−1/2(S+T)=Km Pₒ cos 2Ω

These two quadrature signals are without the DC component and are thus centered on zero. The angle of rotation of the polarizer 114 and of an associated object is then given by
Ω=tan⁻¹(I_{X}/I_{Y})
where Ω is the encoded angle of rotation of the polarizer 114. The angle of rotation calculation is expressed in terms of modulo (½ a shaft turn), and absolute within that increment of ½ a shaft turn. Absolute encoding over a full rotation requires indexing.

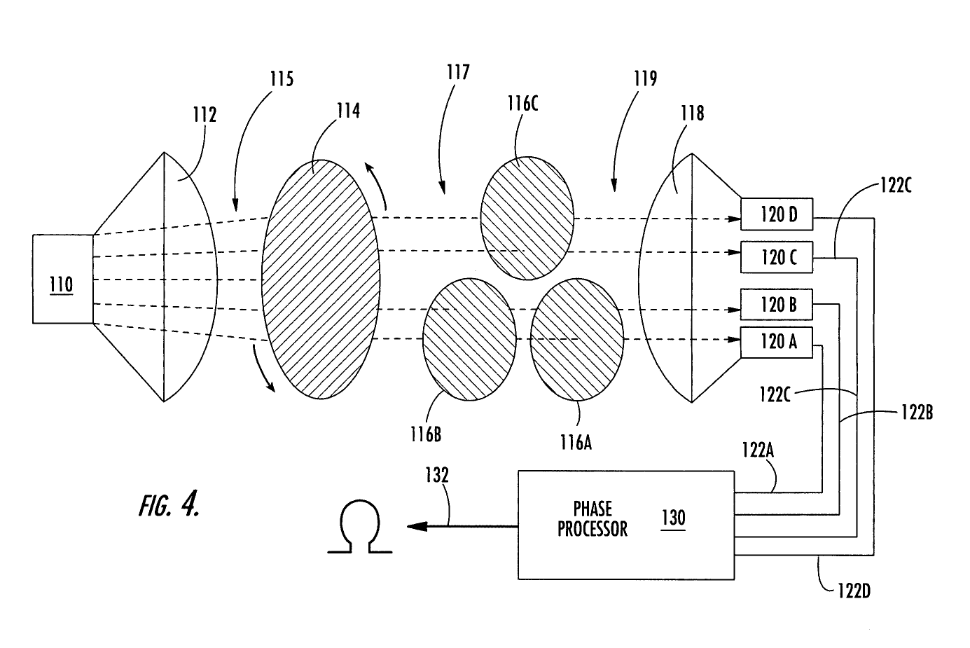

As shown in FIG. 5, a light and dark ring 342A, 342B are marked on the exterior of the polarizer 314 to act as an index. Each ring 342A, 342B identifies a particular ½ of a rotation of the polarizer 314. This index information resolves the modulo of ½ —a rotation ambiguity of the polarizer 314 and facilitates the encoding of the absolute angle of rotation over 360 degrees, a full rotation of the polarizer 314. Light detector 120D is configured to detect light reflecting off of the light 342A and the dark ring 342B. In some embodiments, the light reflecting off of the light 342A and the dark ring 342B originates from the light source 110. In other embodiments, the light reflecting off of the light 342A and the dark ring 342B originates from a source other than the light source 110.

The phase processor 130 processes the intensity of the light received by the light detector 120D in order to determine which half of a full rotation of the polarizer 314, that the polarizer position currently resides in at a particular instant in time.

Hence, (Pₒ), (m) and (Ω) can be solved for mathematically, for each instance in time over a period of time. Solving for (Ω) reveals the angle of polarization (rotation) of the polarizer 114, and of any rotating object (not shown) rotating synchronously with the polarizer 114, at each instance in time over a period of time.

FIG. 5 is simplified block diagram illustrating, in accordance with an embodiment of the invention, the system shown in FIG. 4 utilizing a reflective polarizer 314. The reflective polarizer 314 is disposed perpendicular to the longitudinal axis of a rotating shaft 340. The polarizer 314 rotates synchronously with the rotating shaft 340. Light 115 emitted from a light source 110 and the lens 112 is directed towards the reflective polarizer 314. The reflective polarizer 314 reflects the light 117 emitted from the light source 110 and the lens 112 and redirects it towards the three analyzers 116A-116C.

Light 117 reflected from the reflective polarizer is polarized according to the angle of polarization (rotation) of the reflective polarizer 314. Light 115 emitted from the light source 110 and the lens 112 is preferred to be unpolarized. Each rotation of the rotating shaft 340 causes one rotation of the reflective polarizer 314. Each rotation of the reflective polarizer 314 reflects light 119 that generates two fill sinusoidal cycles of light intensity 124 as measured by the light detectors 120A-120C. Electrical signals 122A-122D are transmitted to the phase processor 130 via communications channels 124.

The index rings 342A, 342B are markings that provide information that identifies which half of a rotation that the angle of rotation of the polarizer 314 is currently residing in. Each half of a rotation corresponds to one sinusoidal cycle of light intensity 124 of the light 119 as measured by each light detector 120A-120C.

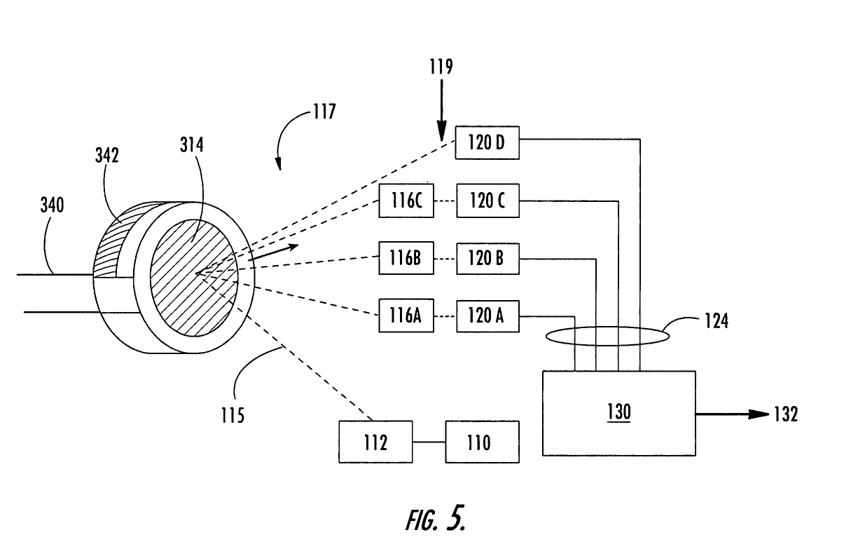

FIG. 6 is simplified block diagram illustrating, in accordance with an embodiment of the invention, the system shown in FIG. 5 utilizing optical fiber links 344, 346 and 348. Optical fiber 344 transmits light 115 emitted from the light source 110 to the lens 112. Optical fiber 346 transmits light passing through each analyzer 116A-116C to each respective light detector 120A-120C. Optical fiber 344 is preferably a non-polarizing optical fiber. Optical fiber 346 transmits a signal output from each respective light detector 120A-120D to the phase processor 130.

Use of the optical fibers enables the light source 110 and the light detectors 120A-120D to be placed outside of an extreme environment. This enables the more sensitive portions of the system to be protected from electromagnetic interference (EMI) and RFI related problems.

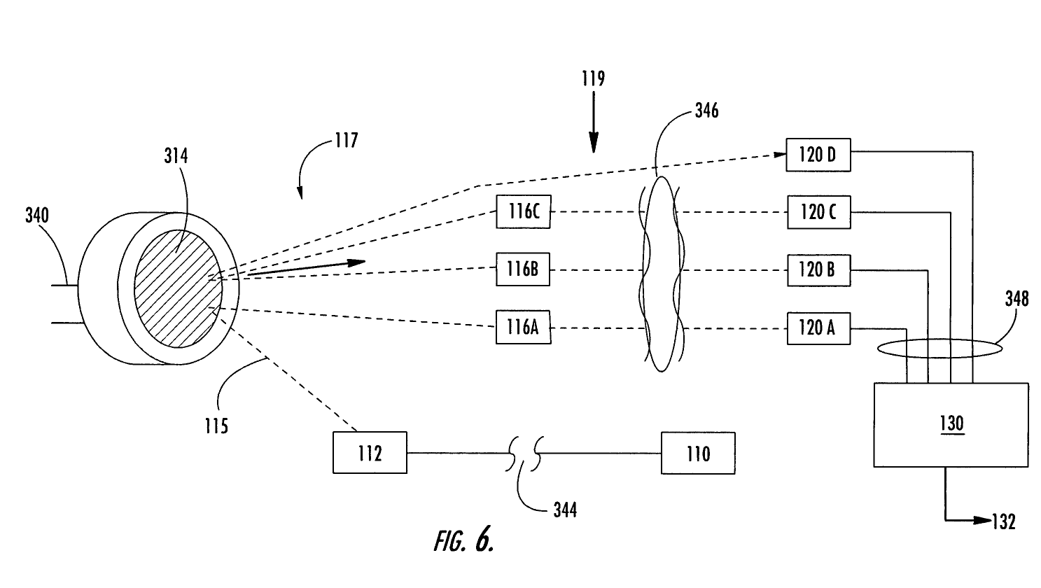

FIG. 7 is simplified block diagram illustrating, in accordance with an embodiment of the invention, the system shown in FIG. 4 utilizing a transmissive polarizer 414. The transmissive polarizer 414 is disposed perpendicular to the longitudinal axis of a rotating shaft 340. The polarizer 414 rotates with the rotating shaft. The light source 110 may or may not rotate with the rotating shaft 340.

The light 119 emitted from a light source 110 and passing through the lens 112 is directed through the transmissive polarizer 414 and towards the three analyzers 116A-116C. The light 119 passing through the transmissive polarizer 414 is polarized by the transmissive polarizer 414 according to its current angle of polarization (rotation). The light 119 emitted from the light source 110 and passing through the lens 112, is preferred to be non-polarized.

Each rotation of the rotating shaft 340 causes one rotation of the transmissive polarizer 414. Each full rotation of the transmissive polarizer 314 transmits light 119 with two full cycles of polarization. After passing through each analyzer 116A-116C, the light 119 transitions through 2 full sinusoidal cycles of light intensity as measured by each light detector 120A-120C.

The index ring 342 is a marking that provides information that identifies which 180 degree half of the polarizer rotational cycle that the polarizer 414 currently resides in. Each half of a rotation corresponds to one sinusoidal cycle of transmitted light intensity as measured by each light detector 120A-120C.

Like shown in FIG. 6, fiber optic cables can be employed for the embodiment shown in FIG. 7. An optical fiber can transmit light emitted from the light source 110 to the lens 112. An optical fiber 346 can transmit light passing through each analyzer 116A-116C to each respective light detector 120A-120C. An optical fiber 346 can transmit a signal output from each respective light detector 120A-120D to the phase processor 130.

FIG. 8 is a simplified block diagram illustrating, in accordance with the invention, a system for non-contact encoding of the angle of rotation of an object utilizing a non-polarizing beam splitter 552. Some of the light emitted from the light source 110 and directed through the lens 112, passes through the non-polarizing beam splitter 552 and towards the reflective polarizer 514. The reflective polarizer 514 may or may not be rotating.

Light 519 passing through the non-polarizing beam splitter 552 reflects off the reflective polarizer 514 and is redirected back towards the non-polarizing beam splitter 552. The non-polarizing beam splitter 552 redirects some of the light 519 reflected from the rotating polarizer 514 towards the light detectors 120A-120D. Likewise, some of the light reflected from the polarizer 514 passes through (not shown) the non-polarizing beam splitter 552 towards the lens 112 while some of this light is reflected upward (not shown) by the non-polarizing beam splitter 552.

Light passing through the analyzers 116A-116C from the non-polarizing beam splitter 552 is optionally communicated via fiber optic cable 346 to the light detectors 120A-120C. The signals generated by the light detectors 120A-120D are optionally communicated to the phase processor 130 via fiber optic cables 348. Light emitted from the light source 110 is optionally communicated to the lens 112 via a fiber optic cable 344.

FIG. 9 is a simplified block diagram illustrating, in accordance with the invention, a system for non-contact encoding of the angle of rotation of a non-rotating object. Various objects 652A-652C are being transported along a conveyor belt 650. A polarizer 654A-654C is associated with and disposed onto each of the objects 652A-652C. Each polarizer 654A-654C is disposed onto an object 652A-652C at an angle of rotation that represents an attribute, such as the orientation of its associated object 652A-652C.

When an object 652A-652C arrives at a particular location 656 along the conveyor belt, light 115 emitted from a light source 110 and lens 112 is directed towards and reflected off of the polarizer 654A-654C associated with and disposed onto the object 652A-652C. The light 117 that is reflected by the polarizer 654A-654C is directed towards the analyzers 116A-116C. Light detectors 120A-120D and the phase processor 130 function in accordance with the description of FIG. 4.

In some embodiments, the polarizers 654A-654C are detachable and reusable. The polarizers 654A-654C can be deployed and disposed onto other objects 652A-652C to indicate their orientation. In some embodiments, the polarizers 654A-654C are disposable.

The embodiments described have various applications including but not limited to, motion control and measurement for various types of motors used for hybrid electric vehicles (HEV), elevators, radar antenna, pick and place applications, cut-to-length of spooled materials such as wires and plastics, programmable logic control units (PLC).

The invention can also be applied to the design of a Linear Variable Differential Transformer (LVDT) and a Rotary Variable Differential Transformer (RVDT) and smart toys.

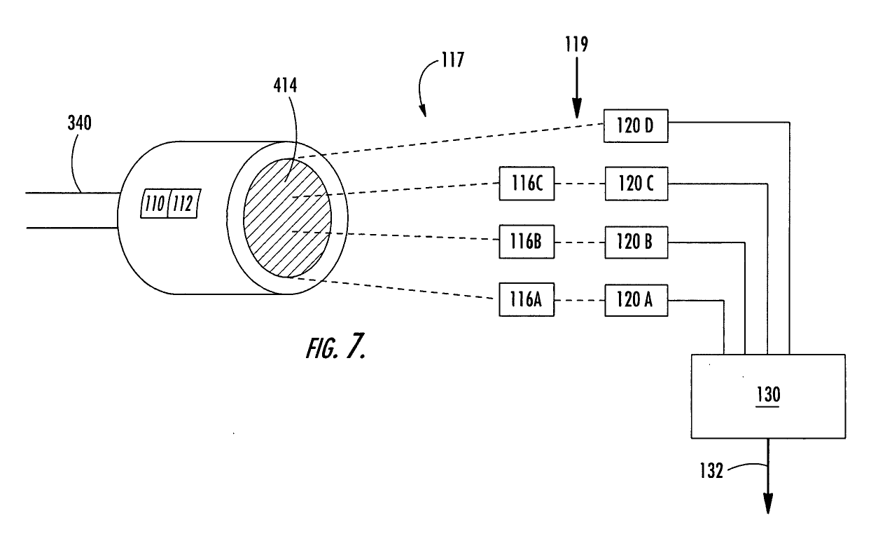

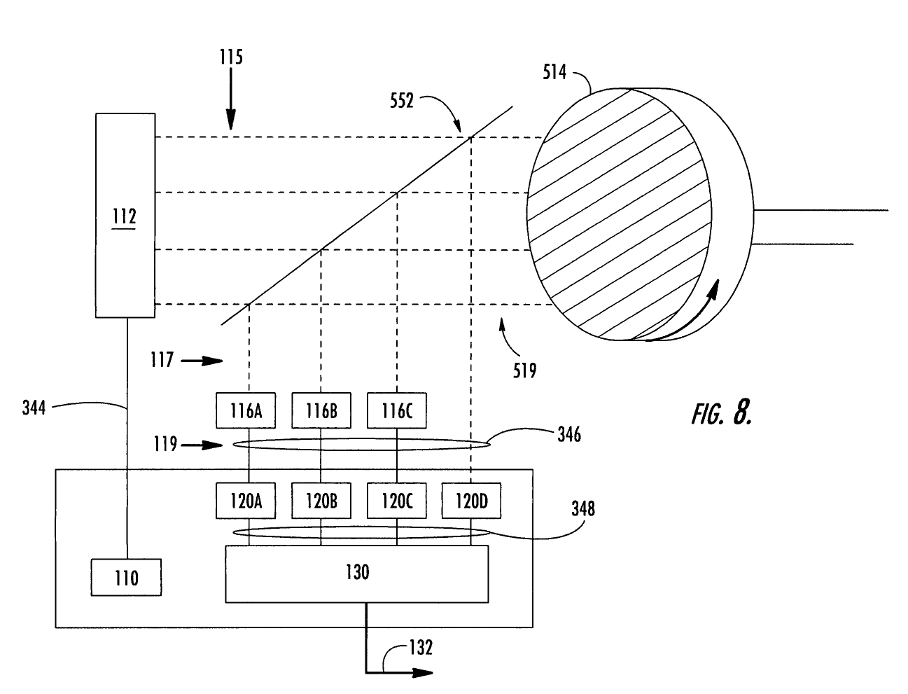

In an alternative embodiment, non-contact optical polarization angle encoder 700, FIG. 10A implements a second phase measurement algorithm within the phase processor. The second phase measurement algorithm does not require the computation of the arc-tangent
Ω=tan⁻¹(I_{X}/I_{Y}) (1)
as described earlier. Angle encoder 700 includes an LED 702 and a head detector 704 that includes three polarizers 116A′, 116B′, 116C′, and three detectors 120A′, 120B′, and 120C′. Detectors 128′-128C′ detect the light from LED 702 that transmits through a rotating polarizing wheel 114′ and the three polarizers 116A′-116C′ respectively. Although LED 702 and head detector 704 are shown as being on opposite sides of polarizing wheel 114′, they could otherwise be located on the same side of polarizing wheel 114′ if it is capable of reflecting light from LED 702 back to head detector 704. The output of detectors 120A′-120C′ respectively, provide three output signals 122A′, 122B′, and 122C′, FIG. 10B.

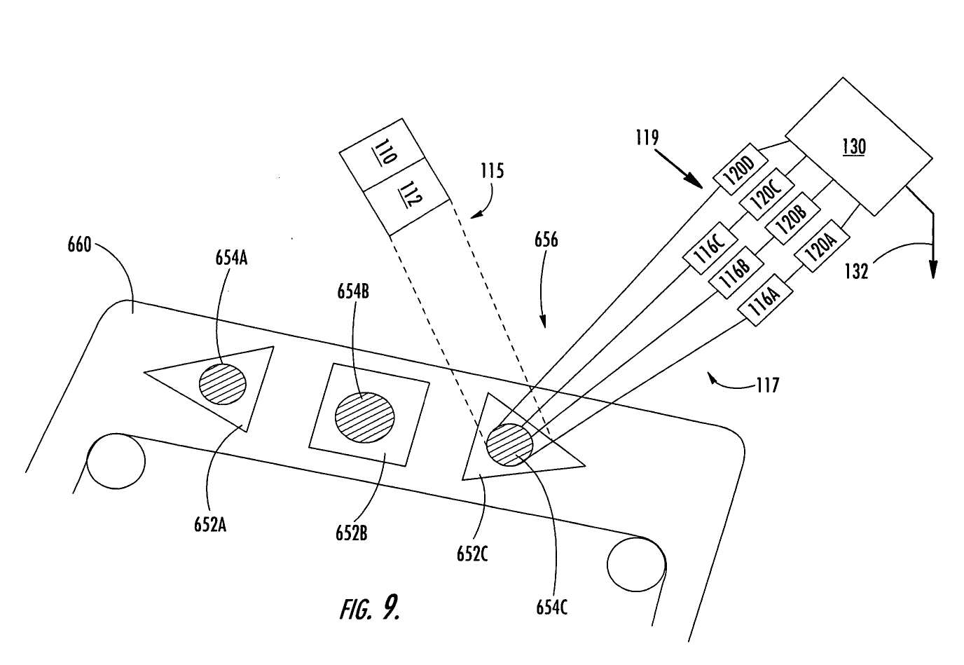

Each of the three simultaneous electrical signals 122A′-122C′, FIG. 11, are sampled at multiple points in time. At time t₁, a top signal 710 is identified as having the highest amplitude, a bottom signal 712 as having the lowest amplitude and a middle signal 714 as having an amplitude not higher than the top signal and not lower than the bottom signal.

A measured amplitude is determined by subtracting bottom signal 712 from middle signal 714. A reference amplitude is determined by subtracting bottom signal 712 from the top signal 710. An amplitude ratio is determined by dividing the measured amplitude by the reference amplitude. Signals 720 and 722, FIG. 12, represent the reference amplitude and the measured amplitude, respectively, for signals 122A′-122C′ in FIG. 11.

The amplitude ratio is proportional to the rotational position of the rotating polarizing wheel 706 within a 180 degree range. When the amplitude ratio equals zero at 724, FIG. 12, the measured amplitude equals zero and the middle signal amplitude equals the bottom signal amplitude. When the amplitude ratio equals one at 726, the middle signal amplitude equals the top signal amplitude.

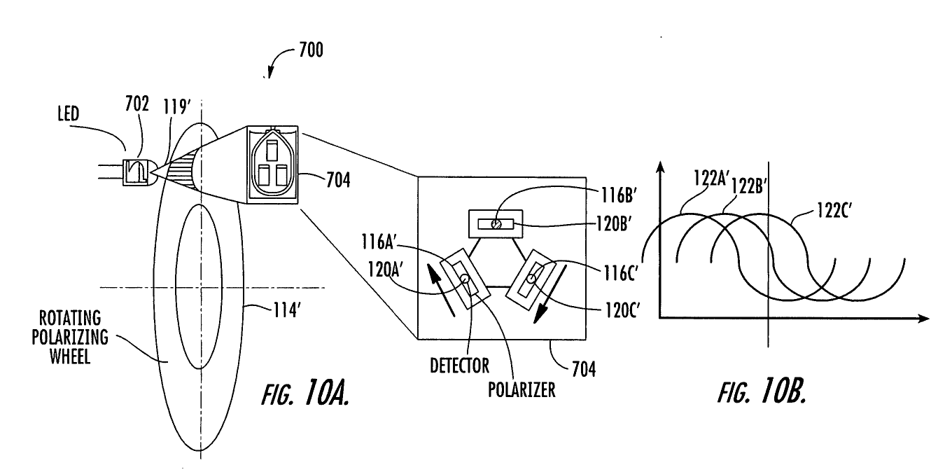

The reference amplitude signal 720, FIG. 13, and the measured amplitude signal 722 are input on lines 730 and 732, respectively, to an analog to digital converter (ADC) to obtain a digital phase data output on line 736. The digital phase data output signal on line 736 corresponds to the amplitude ratio, which may be used to determine the phase of polarizing wheel 114′.

If the analyzers 116A′-116C′ are configured to polarize the light 119′ exactly 120 degrees apart from each other as shown in FIG. 10A, then when the amplitude ratio equals zero, the rotating polarizer 114′ is aligned (parallel) with the one of the analyzers 116A′-116C′ that is associated with the top signal. When the amplitude ratio equals 1.0, the rotating polarizer 114′ is 90 degrees orthogonal (maximally mis-aligned) with the one of the analyzers 116A′-C′ that is associated with the bottom signal. When the amplitude ratio equals 0.5, the rotating polarizer 114′ has a rotational position halfway between the rotational positions at which the amplitude ratio equals zero and one.

A complete rotation of the rotating polarizer 114′ equals 360 degrees of rotational movement. The rotating polarizer 114′ cycles between an amplitude ratio of zero and one every 180 degrees of rotational movement. Consequently, the rotating polarizer 114′ rotates through two 180 degree ranges of rotational movement to complete one 360 degree complete rotation.

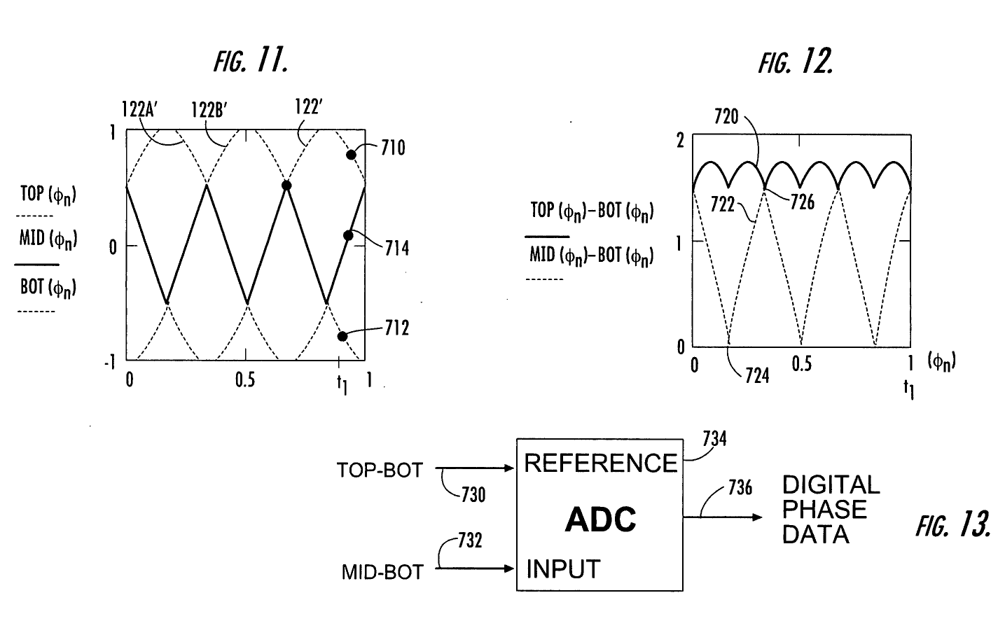

To resolve any ambiguity between the two 180 degree ranges of rotational movement of the amplitude ratio, a polarizing wheel 114A, FIG. 14, which constitutes an embodiment of the rotating polarizer, includes a 2 bit encoder wheel. The 2-bit encoder wheel is a circular area having a black background 750 that resides within the interior of the polarizing wheel. The 2-bit encoder wheel 114A includes 2 semi-circular lines 752 and 754 (slits) that are adjacent to each other in one 90 degree upper right quadrant. One semi-circular line (754) resides interior, closer to the center of the polarizing wheel, than the other semi-circular line 752. Each line 752, 754 allows light to be transmitted therethrough, but in another embodiment would reflect light.

Each quadrant of the polarizing wheel can be identified by a unique combination of semi-circular lines. Upper left quadrant 756 includes only the interior semi-circular line 754, upper right quadrant 758 includes both semi-circular lines 754 and 752, the lower right quadrant 760 includes only the exterior semi-circular line 752 and lower left quadrant 762 includes neither of the semi-circular lines.

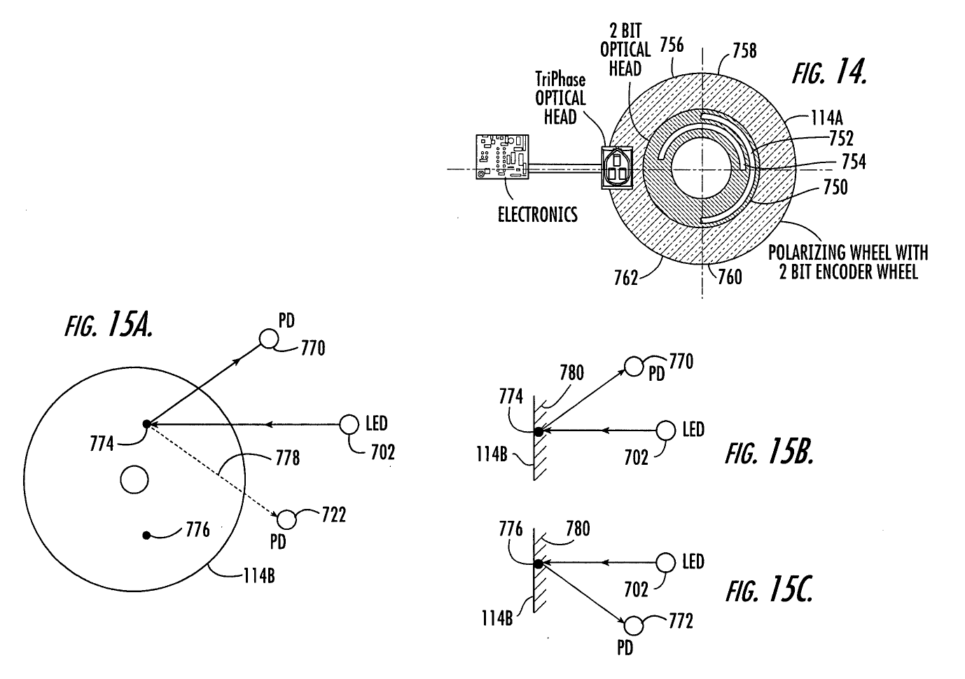

In another embodiment, rotating polarizer 114B, FIG. 15A, has a surface configured to deflect light from LED 702 to either or both of photo detectors 770 and 772 to resolve any ambiguity between the two 180 degree ranges of rotational movement. If LED 702 shines light on spot 774 of polarizing wheel 114B, a light will be reflected only to detector 770. However, if LED 702 shines light on spot 776 once polarizing wheel 114B rotates 180 degrees, then light LED 702 would be reflected only to detector 772 as shown by phantom line 778. If LED 702 shines light upon other spots located between spot 774 and 776, both detectors 772 and 770 would proportionally receive some of the light from LED 702. As seen more clearly in FIGS. 15B and 15C, polarizing wheel 114B can include angled surfaces 780 to reflect light in a desired manner. Surfaces 780 are similar to those typically used in the production of compact discs.

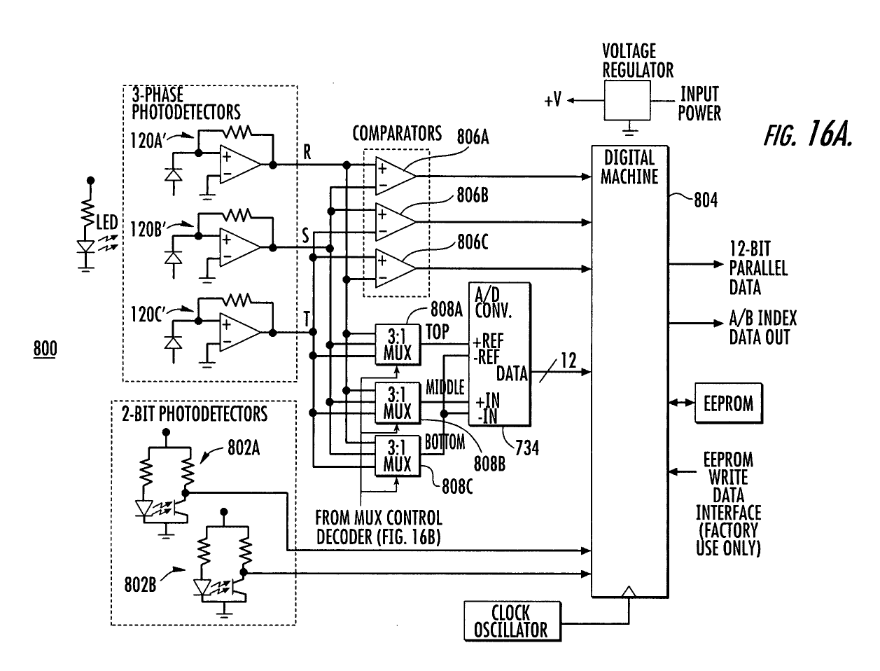

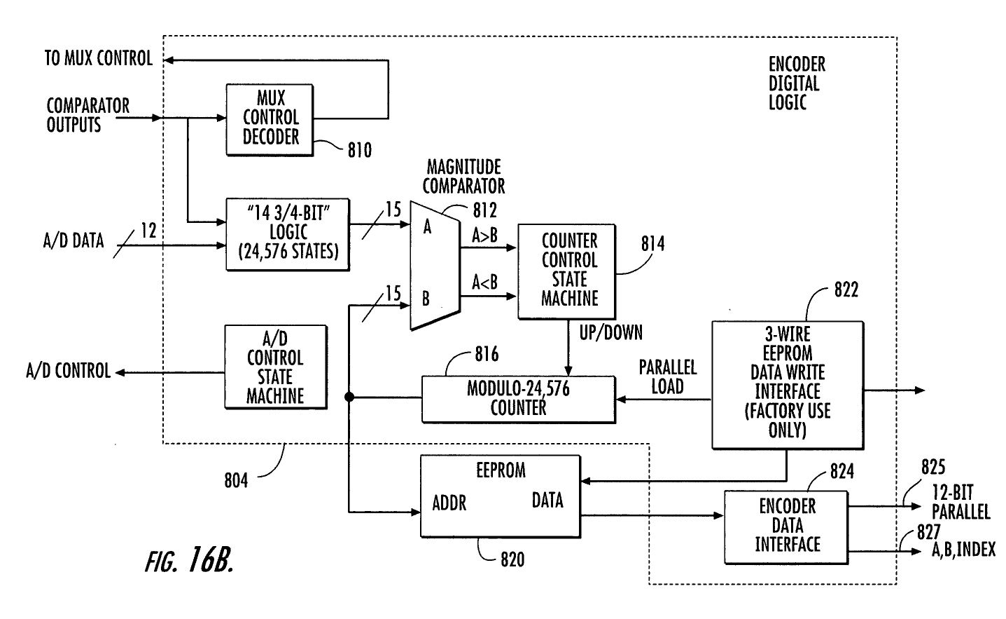

For polarizing wheel 114A of FIG. 14, 2-bit photo detectors 802A, 802B, FIG. 16A, are used to determine at any point in time, which of the two possible 180 degree ranges of rotational movement that the rotating polarizer 114A resides within. Each 2-bit photo detector 802A, 802B is aligned with a unique one of the two semi-circular lines to detect the presence or absence of reflected light associated with the unique one semi-circular line. At any point in time, the absence of reflected light indicates the presence of the associated semi-circular line 752 or 754. The presence of reflected light indicates the absence of the associated semi-circular line 752 or 754.

The amplitude ratio indicates the approximate position of the rotating polarizer 114A within one of two possible 180 degree ranges. The 2-bit polarizers 802A, 802B indicate within which of the two possible 180 degree ranges of rotational movement the amplitude ratio corresponds to and the rotating polarizer 114A resides. Consequently, the combination of the amplitude ratio and information provided by the 2-bit polarizers indicates the approximate position of the rotating polarizer 114A within one complete 360 degree revolution.

A block diagram 800, FIG. 16A, of polarization angle encoder uses the outputs from 2-bit photo detectors 802A and 802B and inputs it into digital machine 804. The outputs of three photodetectors 120A′, 120B′, and 120C′ are input into comparators 806A, 806B and 806C to determine which of these signals is the top, bottom or middle signal. The output of comparators 806A-C are input digital machine 804. The outputs of photodetectors 120A′-C′ are also input into multiplexers 808A, 808B and 808C which select the corresponding input signals as either the top, bottom or middle signal, respectively, and output four signals into ADC 734. The digital code output by ADC 734 is proportional to the ratio: digital code=2ⁿ×(mid-bot)/(top-bot).

Digital machine 804 is shown in greater detail in FIG. 16B, in which a multiplex control decoder 810 is responsive to the outputs of comparators 806A-C and outputs a control signal to control the operation of multiplexers 808A-C. A magnitude comparator 812 is responsive to 12 bit data from ADC 734 and is used to provide information relating to the incremental advance of polarizing wheel 114A. Magnitude comparator 812 is also responsive to a feedback loop that includes state machine 814 and counter 816 so that it can compare the current value of 12 bit data with the prior value of 12 bit data to determine if the value of the 12 bit data has gone up or down.

The 12 bit data from ADC 734 represents a decoded phase angle that maybe preliminary and is the approximate rotational position of the rotating polarizer 114A within the 360 degree range. If the decoded phase angle is preliminary, it is modified by EEPROM 820 with a calibration error value associated with the preliminary decoded phase angle to determine a corrected or final decoded phase angle.

The calibration error value is typically determined after the factory assembly of the angle of rotation encoder. The correction (or calibration) values are stored in EEPROM 820 which is set by factory calibration and can be programmed through interface 822. The calibration error value is determined by measuring the difference between the true angle of rotation of the rotational polarizer 114A and the preliminary decoded phase angle associated with the true angle of rotation of the rotational polarizer 114A. This difference is a calibration error value that is recorded in association with the preliminary decoded phase angle.

The calibration error value compensates for multiple sources of inaccuracies including mis-alignment of the assembled angle of rotation encoder components and the non-linearity of the middle signal which interferes with the complete accuracy of the second algorithm. The preliminary decoded phase angle is modified with a calibration error value associated with the preliminary decoded phase angle to determine a corrected decoded phase angle. The corrected decoded phase angle most accurately represents the true angle of rotation of the rotational polarizer 114A based upon the preliminary decoded phase angle.

Encoder data interface 824 includes a 12-bit parallel data output 825 which provides signals representing an absolute rotational position and also includes an A/B index data output 827 which provides a signal representing an incremental rotational position. The A/B index data output 827 generates a series of pulses over time, each pulse representing a unit of rotational movement, that can be counted via a counter.

Related aspects of the second algorithm are described in the book titled “Excursions in Astronomical Optics”, authored by Lawrence Mertz and published by Springer Verlag (July, 1996), herein incorporated by reference.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Although specific features of this invention are shown in some drawings and not in other drawings, this is for convenience only, as each feature may be combined with any or all of the other features in accordance with the invention.

Other embodiments will occur to those skilled in the art and are within the following claims:

1. An angle of rotation encoder comprising:
a first plurality of analyzers, each responsive to light originating from a light source and configured to polarize the light at a unique angle of polarization;
a first plurality of light detectors, each light detector configured to receive light polarized by a unique one of the first plurality of analyzers and configured to output a signal representing only an intensity attribute of the light polarized by the unique one of the first plurality of analyzers; and
a phase processor configured to compute a value representing an angle of polarization attribute of the light originating from the light source in response to the signal output from each of the first plurality of light detectors.

2. The angle of rotation encoder of claim 1 further comprising a second light detector configured to receive light not being polarized by any of the first plurality of analyzers.

3. The angle of rotation encoder of claim 1 further comprising:
a polarizer configured to rotate synchronously with a first object, configured to be responsive to light originating from the light source and configured to direct light originating from the light source to the first plurality of analyzers.

4. The angle of rotation encoder of claim 2 further comprising:
a polarizer configured to have an angle of rotation that is synchronous with a first object, configured to be responsive to light originating from the light source and configured to direct light originating from the light source to the first plurality of analyzers.

5. The angle of rotation encoder of claim 2 where the first object is rotatable and where the polarizer is configured to rotate synchronously with the first object.

6. The angle of rotation encoder of claim 1 wherein the at least one attribute of the polarized light includes a measurement of the optical power therefrom.

7. The angle of rotation encoder of claim 1 wherein the first plurality of analyzers includes at least three analyzers that each have a unique angle of polarization.

8. The angle of rotation encoder of claim 7 wherein the first plurality of analyzers includes three analyzers having angles of polarization approximately 120 degrees apart.

9. The angle of rotation encoder of claim 3 wherein the polarizer is attached to the first object and configured to reflect and direct light originating from the light source towards the first plurality of analyzers.

10. The angle of rotation encoder of claim 3 wherein the polarizer is attached to the first object and configured to allow the passage of light originating from the light source towards the first plurality of analyzers.

11. The angle of rotation encoder of claim 3 where the light originating from the light source is transmitted to the polarizer through an optical fiber.

12. The angle of rotation encoder of claim 3 further comprising:
a non-polarizing light beam splitter configured to receive light from the polarizer and configured to output at least a first plurality of light beams, each of the light beams being directed to a unique one of the first plurality of analyzers.

13. The angle of rotation encoder of claim 3 where each of the first plurality of light detectors receives light from a unique one of the first plurality of analyzers through an optical fiber.

14. The angle of rotation encoder of claim 12 wherein at least one of the at least a first plurality of light beams is output directly towards the second light detector.

15. The angle of rotation encoder of claim 1 where the phase processor simultaneously samples the signal output from each of the first plurality of light detectors.

16. The angle of rotation encoder of claim 4 where the polarizer is disposable.

17. The angle of rotation encoder of claim 4 where the polarizer is detachable and re-usable on at least a second object.

18. A method of encoding the angle of rotation of an object comprising the steps of:
providing a first plurality of analyzers, each configured to be responsive to light originating from a light source and configured to polarize the light at a unique angle of polarization;
providing a first plurality of light detectors, each configured to receive light polarized by a unique one of the first plurality of analyzers and configured to output a signal representing only an intensity attribute of the light polarized by the unique one of the first plurality of analyzers; and
providing a phase processor configured to compute a value representing an angle of polarization attribute of the light originating from the light source in response to the signal output from each of the first plurality of light detectors.

19. The angle of rotation encoder of claim 1, wherein the phase processor is configured to:
identify at a first time, a top signal having the highest amplitude, a bottom signal having the lowest amplitude and a middle signal having an amplitude not higher than the top signal and not lower than the bottom signal;
determine a measured amplitude by subtracting the bottom signal from the middle signal and to determine a reference amplitude by subtracting the bottom signal from the top signal; and
determine an amplitude ratio by dividing the measured amplitude by the reference amplitude and mapping the amplitude ratio to determine a decoded phase angle.

20. The angle of rotation encoder of claim 19, where the phase processor is configured to:
modify the decoded phase angle with a pre-determined calibration error value to determine a corrected decoded phase angle, the calibration error value associated with the decoded phase angle.

21. The angle of rotation encoder of claim 20, where the calibration error value is equal to the difference between the true phase angle of rotation of the angle of polarization attribute of the light originating from the light source and the decoded phase angle, the calibration error value is recorded in association with the decoded phase angle.

22. The angle of rotation encoder of claim 20 where the phase processor includes:
at least three input comparators, each input comparator configured to test a unique one of the at least three signals and to identify the top signal, the bottom and the middle signal at the first time; and
at least three analog multiplexers, configured to apply the top signal, a middle signal and a bottom signal to an analog to digital converter.

23. The angle of rotation encoder of claim 22 where the analog to digital converter has a plus reference terminal, a minus reference terminal, a plus analog input terminal and a minus analog input terminal and where the top signal is applied to the plus reference terminal, the bottom signal is applied to the minus reference terminal and the middle signal is applied to the plus analog input terminal and the bottom signal is applied to the minus analog input terminal.

24. The angle of rotation encoder of claim 19 further including a 2 bit encoder for indicating to which 180 degree range of rotational movement the amplitude ratio corresponds.

25. The angle of rotation encoder of claim 19 further including a polarizer configured to rotate synchronously with a flat object and having angled surfaces for indicating to which 180 degree range of rotational movement the amplitude ratio corresponds.

26. An angle of rotation encoder system comprising:
a phase processor for determining the phase angle of a rotating mechanism and configured to:
identify at a first time, a top signal having the highest amplitude, a bottom signal having the lowest amplitude and a middle signal having an amplitude not higher than the top signal and not lower than the bottom signal,
determine a measured amplitude by subtracting the bottom signal from the middle signal and to determine a reference amplitude by subtracting the bottom signal from the top signal, and
determine an amplitude ratio by dividing the measured amplitude by the reference amplitude and mapping the amplitude ratio to determine a decoded phase angle.

27. The system of claim 26 in which the phase processor is further configured to:
modify the decoded phase angle with a pre-determined calibration error value to determine a corrected decoded phase angle, the calibration error value associated with the decoded phase angle.

28. The system of claim 27, where the calibration error value is equal to the difference between the true phase angle of rotation of the angle of polarization attribute of the light originating from the light source and the decoded phase angle and where the calibration error value is recorded in association with the decoded phase angle.

29. The system of claim 28 where phase processor includes
at least three input comparators, each input comparator configured to test a unique one of the at least three signals and to identify the top signal, the bottom and the middle signal at the first time;
at least three analog multiplexers, configured to apply the top signal, middle signal and the bottom signal to an analog to digital converter.

30. The system of claim 29 where the analog to digital converter has a plus reference terminal, a minus reference terminal and a plus analog input terminal and a minus analog input terminal and where the top signal is applied to the plus reference terminal, the bottom signal is applied to the minus reference terminal and the middle signal is applied to the plus analog input terminal and the bottom signal is applied to the minus analog input terminal.

31. The angle of rotation encoder system of claim 26 further including a 2 bit encoder for indicating to which 180 degree range of rotational movement the amplitude ratio corresponds.

32. The angle of rotation encoder system of claim 26 further including a polarizer configured to rotate synchronously with a flat object and having angled surfaces for indicating to which 180 degree range of rotational movement the amplitude ratio corresponds.

33. A method for angle of rotation decoding, the method comprising:
identifying at a first time, a top signal having the highest amplitude, a bottom signal having the lowest amplitude and a middle signal having an amplitude not higher than the top signal and not lower than the bottom signal;
determining a measured amplitude by subtracting the bottom signal from the middle signal and determining a reference amplitude by subtracting the bottom signal from the top signal; and
determining an amplitude ratio by dividing the measured amplitude by the reference amplitude and mapping the amplitude ratio to determine a decoded phase angle.

34. The method of claim 33 further including the step of:
modifying the decoded phase angle with a calibration error value to determine a corrected decoded phase angle, the calibration error value associated with the decoded phase angle.

35. The method of claim 33 further including the step of indicating to which 180 degree range of rotational movement the amplitude ratio corresponds.

36. An angle of rotation encoder comprising:
a first plurality of analyzers, each directly responsive to light originating from a light source and configured to polarize the light at a unique angle of polarization;
a first plurality of light detectors, each light detector configured to receive light polarized by a unique one of the first plurality of analyzers and configured to output a signal in response to at least one attribute of the polarized light; and
a phase processor configured to compute a value representing an angle of polarization attribute of the light originating from the light source in response to the signal output from each of the first plurality of light detectors.
